(19) United States
(12) Patent Application Publication
(10) Pub. No.: US 2012/0263951 A1
(43) Pub. Date: Oct. 18, 2012

(54) ELECTRICALLY CONDUCTING NANOCOMPOSITE WIRE COMPRISING TOW OF MULTIWALLED CARBON NANOTUBES AND TRANSVERSE METAL BRIDGES

(75) Inventors: Fred Michael Mueller, Los Alamos, NM (US); Chris Randall Rose, Los Alamos, NM (US); Kenneth Ralph Marken, Los Alamos, NM (US); Raymond F. DePaula, Santa Fe, NM (US); Terry George Holesinger, Los Alamos, NM (US)

(73) Assignee: LOS ALAMOS NATIONAL SECURITY, LLC., Los Alamos, NM (US)

(21) Appl. No.: 13/248,587

(22) Filed: Sep. 29, 2011

Related U.S. Application Data
(63) Continuation-in-part of application No. 13/088,042, filed on Apr. 15, 2011.

(51) Int. Cl. D02G 3/00; B29C 67/24; B82Y 30/00

(52) U.S. Cl. 428/364; 264/105; 977/752

(57) ABSTRACT

Nanocomposite wires having conductivities higher than for metal wires were prepared by pulling tows from a supported array of multiwalled carbon nanotubes and sputter depositing metal on the tows, which resulted in transverse bridges between adjacent nanotubes in the tows. These transverse bridges of metal attached adjacent nanotubes to each other and provided paths for electricity to flow from one nanotube to another.

### RELATED APPLICATIONS

This application claims the benefit of U.S. application Ser. No. 13/088,042 entitled “Ultraconducting Articles,” filed Apr. 15, 2011, which claimed the benefit of U.S. Provisional Application 61/321,531 entitled “Ultraconducting Articles, filed Apr. 15, 2010, both incorporated by reference in their entireties.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates generally to the preparation of electrically conductive nanocomposite wires from tows of aligned multiwalled carbon nanotubes, and metal.

### BACKGROUND OF THE INVENTION

Metals are good electrical conductors and are easily drawn from molten metal and formed into wires. Most transmission lines and power conductors are currently based on copper and aluminum alloys. Superconducting tapes are alternative conductors that offer an advantage over metal wires of no-loss DC power transmission, but superconductors are brittle, require continuous cryogenic cooling, and are subject to both critical current and magnetic quench. Electrical conductors that conduct electricity better than metal wires do and that are not subject to the critical current and magnetic quench of superconductors would be desirable.

### SUMMARY OF THE INVENTION

The invention relates to a method for preparing an electrically conducting nanocomposite wire. The method includes pulling a tow of aligned multiwalled carbon nanotubes from a supported array of the multiwalled carbon nanotubes, and forming transverse bridges that connect adjacent multiwalled carbon nanotubes to each other. The bridges include elemental metal or alloy, and provide paths for electricity to flow from one nanotube to another when a voltage is applied across the nanocomposite wire.

The invention is also related to a nanocomposite wire prepared by a process comprising: pulling a tow of aligned multiwalled carbon nanotubes from a supported array of the multiwalled carbon nanotubes, and forming transverse bridges that connect adjacent multiwalled carbon nanotubes to each other. The bridges include elemental metal or alloy. The bridges provide paths for electricity to flow from one nanotube to another when a voltage is applied across the nanocomposite wire. Embodiments include double-walled having an inner wall and an outer wall, and bridges of elemental metal or alloy extend through the outer wall to the inner wall of the nanotubes.

The present invention relates to electrically conducting articles that are nanocomposite wires. These wires include a tow of aligned multiwalled carbon nanotubes, and transverse bridges of elemental metal or metal alloy that attach adjacent carbon nanotubes to each other and provide paths for electricity to flow from one nanotube to another. Embodiments include double-walled carbon nanotubes having an inner wall and an outer wall, and bridges of elemental metal or alloy that extend through the outer wall to the inner wall of the nanotubes

### BRIEF DESCRIPTION OF THE DRAWINGS

FIG. 1 shows an image of the formation of a tow of aligned multiwalled carbon nanotubes by pulling the nanotubes from a supported array of the nanotubes.

FIG. 2 shows a TEM image of several carbon nanotubes from Sample 15 after gold is sputtered on them. The image shows that the nanotubes are multiwalled and include double-walled nanotubes. The gold particles decorate portions in-between the inner wall and outer wall, and are in contact with the outer wall. These particles are believed to contact portions of the nanotubes known as Stone-Wales defects, which include a rigid pair of carbon rings of a five-membered ring attached to a seven-membered ring through a common carbon-carbon bond.

FIG. 3 shows a sketch of a deposition set-up including five tows of multiwalled CNTs in position for deposition and subsequent measurements.

### DETAILED DESCRIPTION

The present invention is concerned with electrically conducting nanocomposite wires prepared by pulling a tow of aligned, multiwalled carbon nanotubes from a supported array of the nanotubes, and then forming transverse metal bridges of elemental metal or alloy between adjacent nanotubes in the tow that allow electricity to flow from one nanotube to another in the tow. The bridges are formed from metal deposition onto the tow. The electrical conductivities of nanocomposite wires of this invention exceeded the conductivities of metal wires having the same dimensions and metal used to prepare nanocomposite wires. In some cases, the electrical conductivity for an embodiment nanocomposite wire exceeded the electrical conductivity of a metal wire by more than 100%. In the art of composites, a tow is an untwisted bundle of fibers or filaments.

Carbon nanotubes (CNTs) have hollow, soda-straw-like structures of sp²-hybridized carbon with a conjugated π-system. Individual CNTs may be considered one-dimensional objects due to their small outer diameters (about 11 nm for double walled CNTs) and high length-to-width aspect ratio (e.g. 10,000 for nanotubes 10 nm in diameter and 100 micrometers in length). Individual CNTs are so tiny that over 370 million aligned CNTs can fit into a cross sectional area of 25 micrometers by 25 micrometers, which is approximately the cross sectional area of a human hair. Single CNTs have a tensile strength of 63 GPa, or about 50 times that of metal piano wire. They have a thermal conductivity of about 3500 W m⁻¹ K⁻¹ or about nine times more than that of diamond. They have a density of 1.3 g/cm³, which is less than that of commercial carbon fibers (1.8-1.9 g/cm³), and a high stiffness to weight ratio, and a Young's modulus about 5 times higher than that of carbon fibers. CNTs also have interesting electrical properties that range from highly conductive metals to semiconductors with a large band gap. Metallic CNTs, such as those used to prepare the nanocomposite wires of this invention, can have conductivities 1200 times higher than copper. CNTs have very low energy dissipation and can carry approximately 10,000 times greater current densities than superconducting wires. Unlike metal wires, which have a conductance that is inversely proportional to their length (i.e. G=A/ρL), where A is the cross sectional area, ρ is the resistivity, and L is the length of the wire, CNTs have a quantum conductivity ‘G’ that is independent of length and can be calculated using the following equation:

G=2e²/h

wherein ‘e’ is the fundamental charge of an electron and ‘h’ is Planck's constant. Thus, a single CNT has an effective resistance of 12,500 ohm. This equation represents an ideal case of a perfect CNT with one end and only two states: either (1) the CNT conducts this value of G or (2) the CNT is nonconducting. Hence, a CNT can act as an ideal conduit for electrons. Unfortunately, current methods for preparing metallic CNTs tend to result in lengths of individual CNTs on the order of hundreds of microns to millimeters. Therefore, to make use of the electrical conductance properties of CNTs a few hundred microns long, it is necessary to manipulate on the order of 10¹⁸ CNTs to form them into practical conductors. Furthermore, there must be some way of transmitting the conductivity from one CNT to another. These problems have been addressed in this invention by preparing a tow of individual multiwalled CNTs from a supported array, and then providing electrically conductive metal connections in-between the nanotubes of the tow.

A tow useful for the preparation of nanocomposite wires of this invention was prepared from an array of aligned, metallic-type CNTs on a supported catalyst. These CNTs were multiwalled, which include but not limited to double-walled CNTs. In an embodiment, a tow was prepared by pulling metallic-type CNTs grown from a supported catalyst employing a support that was a commercially available virgin silicon wafer with a thickness of from about 30 mils (one mil=one thousandth of an inch) to about 60 mils and with a diameter of from about 2 inches to about 6 inches. A passivating layer of silicon nitride with thickness from about 20 microns to about 60 microns was deposited on a silicon wafer. Next, a buffer layer of aluminum oxide having a thickness of from about 200 angstrom to about 1500 angstrom was deposited by Ion Beam Assisted Deposition (“IBAD”) on the silicon nitride layer. Next, a catalyst layer was deposited on the aluminum oxide layer. The catalyst layer is a layer of metal selected from groups VIII, IB, and IIB from the periodic table. These elements are Fe, Ru, Os, Co, Rh, Ir, Ni, Pd, Pt, Cu, Ag, Au, Zn and Cd. Preferred catalyst metals are Fe, Co, or Ni.

A desired thickness of catalyst layer was determined by first making a run referred to herein as a “witness run” which is a long deposition of metal on the substrate, measuring the thickness of the resulting metal layer, and then using the time taken to produce this thickness to accurately scale the thickness of a shorter deposition. A witness run was used to control the catalyst thickness in the range of from about 1 to 50 Angstroms. Depositions were typically performed by metallic sputtering, which is a conventional commercially available thin-film deposition tool. The sputtering technique forms reliable thin film depositions that result in the formation of metal particles that extend from within the walls to outside the CNTs, which results in transverse metal bridges that attach adjacent carbon nanotubes from the tow to each other and provide the means for conducting electricity from one nanotube to another.

An array of carbon nanotubes was prepared using the supported catalyst. The nanotube growth took place inside a chamber. The supported catalyst was placed inside a chamber. Then, the temperature of the chamber was increased from 20 degrees Celsius to 900 degrees Celsius while a flowing atmosphere of argon having a density of from about 50 sccm to about 300 sccm was sent through the chamber. The argon gas used was ultrahigh purity having a purity of 99.9999% or better. When the temperature reached 900 degrees Celsius, the chamber was maintained at this temperature for about 5 to 10 minutes for thermal equilibration, and then the gas was switched from argon gas to forming gas (a gaseous mixture of argon plus about 4% H₂), and then a hydrocarbon gas such as ethylene was added to the forming gas, and the flow of the gas was changed to a flow of about 13 sccm to about 30 sccm, and the carbon nanotubes were allowed to grow in the form of a parallel array perpendicular to the catalyst surface for a period of time from about 10 minutes to about 50 minutes, after which the flow of the carbon containing gas was stopped and the chamber was allowed to cool to room temperature over a period of from about 5 minutes to about 120 minutes. The result was a carbon nanotube array having a height, measured perpendicular to the plane of the catalyst surface, of from about 100 microns to longer than 10,000 microns.

The carbon nanotubes were multiwalled, including double walled nanotubes having an inner wall diameter of about 7.50 nanometers (nm) and an outer wall diameter of about 10.98 nm. These arrays were arrays of carbon nanotubes of the metallic type.

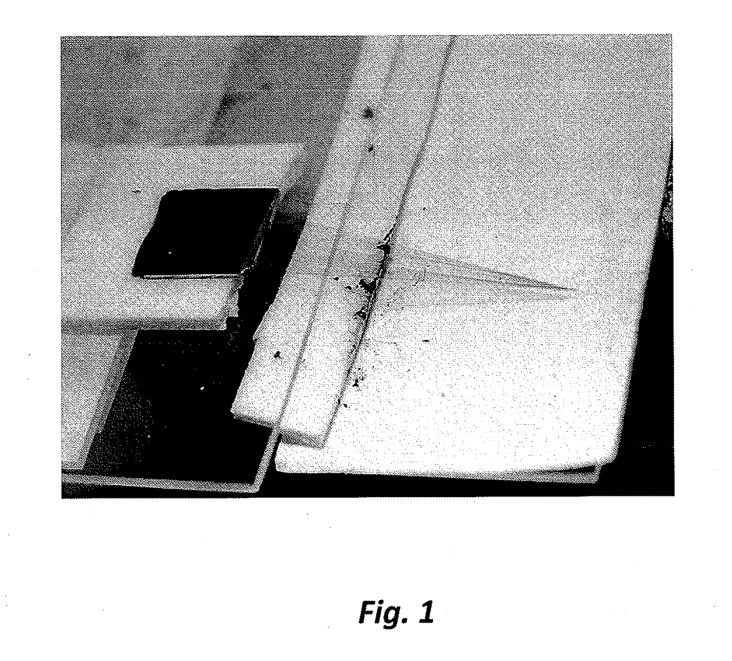

The nanotubes were pulled from the array into a tow of aligned carbon nanotubes. FIG. 1 depicts the formation of a tow of aligned metallic carbon nanotubes from an array.

The tow itself does not have the electrical conductivity needed for a practical electrical conductor because the electrons cannot easily jump from one CNT to an adjacent one. The tow was modified according to the invention to provide the electrical conductivity for a practical electrical conductor by making use of defects in the CNTs that serve as routes through which electrons can enter and leave a nanotube's conductive path by providing electrical connections amongst these defects in adjacent CNTs in the tow. These defects are known as Stone-Wales defects. The synthesis of CNTs by catalytic processes creates Stone-Wales defects in which a rigid pair of hexagonal rings is periodically replaced by a rigid pair of a five membered ring connected and a seven membered ring connected to the five membered ring through a common carbon-carbon bond. In these CNTs, these rigid pairs of five and seven membered rings are known in the art as Stone-Wales defects. It is believed that these defects appear periodically in CNTs that are prepared from the catalyst supported arrays, and are believed to be separated from each along the longitudinal direction of the CNT by 66 normal rigid pairs of hexagonal rings.

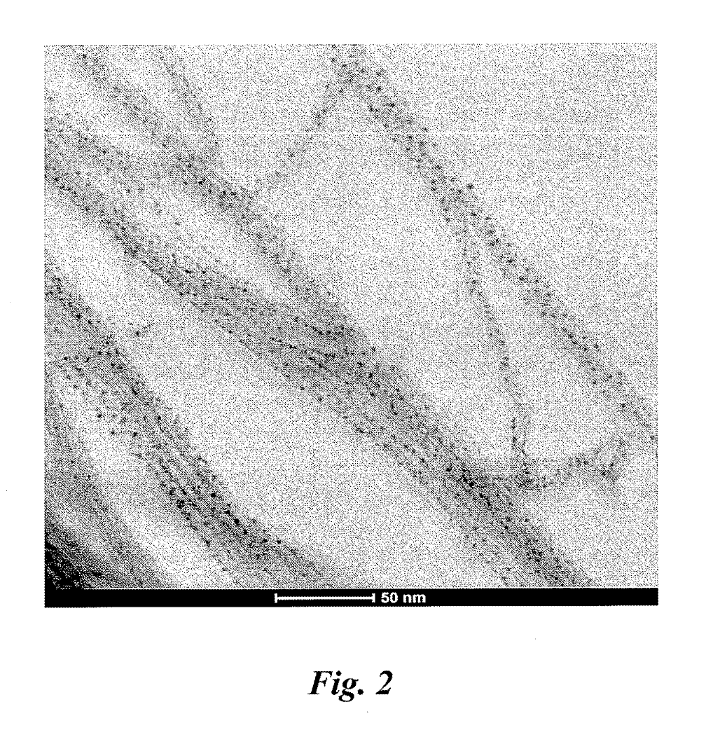

Highly magnified images of CNTs after metal deposition onto a tow show small particles of metal in between the inner wall and outer wall of double-walled CNTs (see FIG. 2). These metal particles extend through the outer walls of the CNTs and provide bridges for conducting electricity from one CNT to another. Without wishing to be bound by any theory or explanation, it is believed that at least some of these particles are in contact with the Stone-Wales defects. The metals that decorate these defects are drawn from Groups VIII, IIA, and IIB of the Periodic Table.

In practical electrical conductors of this invention, the transverse metal bridges form a percolative conductive matrix that is dominated by the high longitudinal electrical conductivity of the CNTs themselves. These transverse bridges extend through the outer walls to the inner walls of the CNTs. We have calculated that the resistance of a single Stone-Wales defect decorated with metal is about 5 ohm. The resistance of going from one defect to another is negligible compared to the resistance of 12,500 ohm through a tube.

After the tow is pulled from the array, it is subjected to a suitable procedure that results in the production of transverse metal bridges in-between adjacent carbon nanotubes of the tow. This is typically a metal deposition that results in metal located in between the inner wall and the outer wall of the double walled carbon nanotubes. FIG. 2 shows a TEM image of double walled carbon nanotubes after being subjected to gold (Au) sputtering. As the image shows, particles having about 25 atoms of gold are shown to decorate the inner walls of the double-walled carbon nanotubes.

Enough metal is deposited so that transverse bridges of metal form that provide electrical connections in-between connect adjacent carbon nanotubes of the tow. The result is a nanocomposite wire. The bridges extend through the outer walls and into the inner walls of the carbon nanotubes, and form a conductive path in the direction transverse to the axis of the CNT.

Embodiments of nanocomposite wire were prepared. The electrical conductivity of most of these was measured and was found to exceed the conductivity of metal wire. In some embodiments, the electrical conductivity of the nanocomposite wires exceeded the electrical conductivity of metal wire by more than 100%. The electrical conductivity data is summarized in Tables 1 through 4 (vide infra).

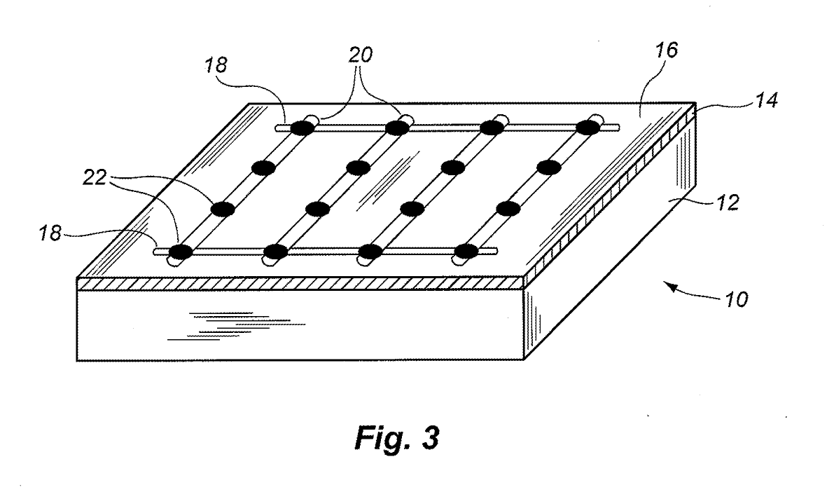

Embodiment nanocomposite wires were prepared using an array of multiwalled carbon nanotubes. A tow was pulled from the array, and then metal was deposited on the tow. FIG. 3 shows a sketch of a deposition set-up 10 including five tows of multiwalled CNTs in position for deposition and subsequent measurements. In a typical procedure, a conducting plate surface 16 (gold, for example) was first provided by depositing a thin layer 14 of metal such as gold on a glass microscope slide 12. Afterward, very thin conducting wires 18 (gold, for example) were mounted across the conducting plate surface 16, and then one or more tow samples 20 were placed parallel to each other on the conducting wires 18. After placement of the tows, they were secured to the gold wires with silver paste 22, which had a negligible conductivity compared to the conducting plate surface 16 and conducting wires 18. Silver paste 22 was also used to secure middle portions of the tows to the metal coated slide. There was typically room for placing five tows 20 parallel to each other. After the tows were secured to the conducting wires 18 and conducting plate surface 16, they were subjected to a metal sputtering process that deposited metal (e.g. gold, copper) on the tow 20 and also onto conducting plate surface 16. As we discovered later (see FIG. 2), the sputtering resulted in particles of metal that extended through the outer walls to the inner walls of the CNTs. These particles provide conducting metal bridges between adjacent CNTs. After the metal sputtering, electrical measurements were made using a 4 point technique.

After the sputtering, the resistance in ohms for each of the nanocomposite wires was measured. A series of experiments were done to accurately separate the conductivity in the nanocomposite wires from the conductivity of the ancillary metal-coated glass microscope slides. Tables 1 and 2 below summarize the total gold thickness, and the length, width, resistance in (Ω) and resistivity (ρ, in nano-ohm times meters) of the nanocomposite wire, and the calculated enhancement in conductivity for the nanocomposite wire. A micro-caliper was used for measuring the lengths and widths of the nanocomposite wire samples. The micro-caliper has an accuracy of 10 microns. All electrical measurements used a 4 point technique.

TABLE 1

| Sample Number | Control 1 | Sample 1 | Sample 2 | Sample 3 | Sample 4 | Sample 5 |
|---|---|---|---|---|---|---|
| Total Au thickness | 100 | 110 | 110 | 105 | 110 | 110 |
| (nm) (slide + tow) | | | | | | |
| Length (mm) | 2.395 | 2.730 | 4.125 | 3.460 | 5.880 | 2.911 |
| Width (mm) | 7.53 | 10.31 | 8.36 | 7.52 | 6.61 | 7.73 |
| Resistance (Ω) | 0.139 | 0.067 | 0.128 | 0.1392 | 0.253 | 0.109 |
| Resistivity (n Ω · m) | 4.37 | 2.78 | 2.59 | 3.02 | 3.13 | 3.14 |
| Conductivity | 0% no tow | +57.2% | +68.7% | +44.7% | +39.6% | +39.2% |
| enhancement | | | | | | |
| Treatment | Glass slide | Additional | Additional | Additional | Additional | Additional |
| | (substrate) | 10 nm Au | 10 nm Au | 5 nm Au | 10 nm Au | 10 nm Au |
| | coated | deposited | deposited | deposited | deposited | deposited |
| | with 100 | on tow | on tow | on tow | on tow | on tow |
| | nm Au | and slide | and slide | and slide | and slide | and slide |

TABLE 2

| Sample Number | Sample 6 | Sample 7 | Sample 8 | Sample 9 | Sample 10 | Sample 11 |
|---|---|---|---|---|---|---|
| Total Au thickness | 105 | 105 | 105 | 110 | 107.5 | 107.5 |
| (nm) slide + tow | | | | | | |
| Length (mm) | 4.205 | 2.360 | 3.681 | 3.170 | 2.000 | 4.02 |
| Width (mm) | 9.79 | 9.84 | 9.90 | 10.20 | 8.690 | 11.55 |
| Resistance (Ω) | 0.119 | 0.079 | 0.132 | 0.0987 | 0.1280 | 0.164 |
| Resistivity (n Ω · m) | 2.90 | 4.44 | 3.72 | 3.21 | 5.98 | 5.07 |
| Conductivity | +50.7% | +27.0% | +17.5% | +36.1% | +103% | +68% |
| enhancement | | | | | | |
| Treatment | Additional | Additional | Additional | Additional | Additional | Additional |
| | 5 nm Au | 5 nm Au | 5 nm Au | 10 nm Au | 7.5 nm Au | 7.5 nm Au |
| | deposited | deposited | deposited | deposited | deposited | deposited |
| | on tow | on tow | on tow | on tow | on tow | on tow |
| | and slide | and slide | and slide | and slide | and slide | and slide |

Samples 1 through 11 were prepared by first depositing 100 nm of gold on a glass microscope slide. The entries in Table 1 for Au thickness refer to the total thickness of gold deposited, which include the first 100 nm of gold deposited on the glass slide and a smaller amount of gold deposited after placing CNT tow onto the gold surface. After depositing a thin film of 100 nm of gold on the glass slide, gold wires were placed onto the slide, and then tows of aligned multi-walled carbon nanotubes that were pulled from an array were placed on the gold wires and gold surface. They were arranged parallel to each other on the gold surface. Afterward, silver paste was used to secure the tows to the gold wires and gold surface. After securing the tow, gold was deposited by sputtering onto the tows. For samples 1, 2, 4, and 5, an additional 10 nm of Au was deposited. For Examples 4, 6, 7, and 8, an additional 5 nm of gold was deposited. For samples 10 and 11, an additional 7.5 nm was deposited. The length and width of each nanocomposite wire was measured accurately with micro-calipers. The electrical resistance of each coated tow was measured. The electrical conductivity was then known, and from this, the enhancement in conductivity was calculated by comparing the electrical conductivity of a nanocomposite wire with the electrical conductivity of a gold wire having the same length and width as the nanocomposite wire. As the data show, each of samples 2 through 6 displayed an electrical conductivity that was greater than the electrical conductivity of a gold wire of the same size as the corresponding nanocomposite wire. Samples 1 through 11 all had enhanced conductivities compared to gold wires of the same dimensions as the nanocomposite wires. The enhancement for sample 10 was greater than 100%. Table 3 below provides a summary for additional samples of gold sputtered tow, yielding nanocomposite wire.

TABLE 3

| Sample Number | Control 2 | Sample 12 | Sample 13 | Sample 14 | Sample 15 | Sample 16 |
|---|---|---|---|---|---|---|
| Au thickness (nm) | 100 | 115 | 110 | 130 | 130 | 260 |
| slide + tow | | | | | | |
| Length (mm) | 5.31 | 5.89 | 6.37 | 4.50 | 5.24 | 6.09 |
| Width (mm) | 12.91 | 10.96 | 9.85 | 10.11 | 10.00 | 9.17 |
| Resistance (Ω) | 0.207 | 0.208 | 0.278 | 0.164 | 0.227 | 0.108 |
| Resistivity (n Ω · m) | 5.03 | 4.451 | 4.726 | 4.79 | 5.63 | 4.23 |
| Enhancement in | 0% no tow | 94% | 64% | 101% | 113% | 26% |
| conductivity | | | | | | |
| Treatment | Glass | Additional | Additional | Additional | Additional | Additional |
| | substrate | 15 nm Au | 10 nm Au | 30 nm Au | 30 nm Au | 160 nm Au |
| | coated | deposited | deposited | deposited | deposited | deposited |
| | with 100 | on tow | on tow | on tow | on tow | on tow |
| | nm Au | and slide | and slide | and slide | and slide | and slide |

As Table 3 shows, samples 14 and 15 displayed an enhancement in conductivity of greater than 100%. Sample 16 with an enhancement of 26% was the sample with the highest sputtered amount of gold on the tow. The decrease in enhancement for this sample, with the thickest coating of all the samples, suggests that that the conductivity properties of the coated tows become more and more like copper as the thickness of the deposition becomes greater, and that the quantum conductivity advantages of the nanotubes diminish as the coating thickness of the copper increases.

FIG. 2 shows a TEM image a portion of Sample 15 of carbon nanotubes after gold is sputtered on them. The image shows that the nanotubes are multiwalled, in particular double-walled, and that gold particles decorate portions in-between the inner wall and outer wall, and are in contact with the outer wall. These particles are believed to contact portions of the nanotubes known as Stone-Wales defects, which include a rigid pair of carbon rings of a five-membered ring attached to a seven-membered ring through a common carbon-carbon bond.

A series of nanocomposite wires were prepared by forming substrates of gold coated glass microscope slides, as described before but with a thinner (70 nanometers) gold layer, and securing tows to the gold wires on the slides, as described before. Five tows were secured, and then the tows were treated by sputter depositing copper on the tows. Table 4 provides a summary of thickness, length, width, resistance, resistivity, enhancement in conductivity, and treatment.

TABLE 4

| | Sample Number | | | | |
|---|---|---|---|---|---|
| | Sample 26 | Sample 27 | Sample 28 | Sample 29 | Sample 30 |
| Total Au | 70 nm Au + | 70 nm Au + | 70 nm Au + | 70 nm Au + | 70 nm Au + |
| thickness | 50 nm Cu | 20 nm Cu | 40 nm Cu | 16 nm Cu | 5 nm Cu |
| (nm) | | | | | |
| slide + tow | | | | | |
| Length (mm) | 5.57 | 5.91 | 4.64 | 5.32 | 4.85 |
| Width (mm) | 10.10 | 11.25 | 11.26 | 10.98 | 9.61 |
| Resistance | 0.209 | 0.211 | 0.115 | 0.172 | 0.185 |
| (Ω) | | | | | |
| Resistivity | 12.33 | 7.87 | 7.88 | 7.68 | 7.88 |
| (nΩ · m) | | | | | |
| Enhancement | 34% | 65.4% | 42% | 98.1% | 76.99% |
| in | | | | | |
| conductivity | | | | | |
| Treatment | Glass | Glass | Glass | Glass | Glass |
| | substrate | substrate | substrate | substrate | substrate |
| | coated with | coated with | coated with | coated with | coated with |
| | 70 nm gold, | 70 nm gold, | 70 nm gold, | 70 nm gold, | 70 nm |
| | tow coated | tow coated | tow coated | tow coated | gold, tow |
| | with 50 nm | with 20 nm | with 40 nm | with 16 nm | coated with |
| | copper | copper | copper | copper | 5 nm |
| | | | | | copper |

As Table 4 shows, every sample of tow sputtered with copper showed an enhancement in conductivity compared to a pure copper wire. Sample 29 showed the highest enhancement in conductivity. A review of samples 26 through 30 reveals a pattern that relates the amount of copper sputter deposited on the tow and the enhancement in conductivity. Sample 30 shows an enhancement of about 77% with 5 nm of copper sputter deposited on the tow. Sample 29 shows a greater enhancement with 16 nm copper. Sample 27 shows an enhancement of 65 4% with a bit more copper. Sample 28 shows an enhancement of 42% with still more copper deposited, and sample 26 shows less enhancement (34%) with still more copper deposited. The numbers show a maximum enhancement peaking at a deposition of 16 nm copper, and more or less than this amount produced less of an enhancement to the conductivity. Sample 29, the sample with the maximum enhancement, is produced with 16 nm copper, which is just under 1 atomic layer of copper.

By using data from a variety of experiments, a simple and coherent picture emerges: the changes in CNT conductivities found for the nanocomposite wires were far larger (namely >100%) than our deposition error (<1%) in the witness experiments.

Control samples are samples without CNT tow, which have an enhancement of zero percent. At a thickness of 10-30 nm, we found a consistent point of optimal conductivity enhancement. With a thickness as low as 5 nanometers of sputtered metal, we found an enhancement of up to about 50%. As more and more metal was deposited, the enhancement grew to a value that approached and in some cases exceeded 100%, However for very thick depositions, the enhancement decreased. For thickness larger than this optimal value, the conductivity data returned to a condition of less and less differential conductivity improvement. The later data suggest that a very large thickness would yield a zero enhancement. We believe that the deposition of metal on the tow results in a nanocomposite wire with a percolative conductivity.

It is believed that the enhanced conductivity that has been demonstrated with the nanocomposite wires of this invention can have a wide ranging impact on a variety of applications such as electrical power transmission. It is believed that nanocomposite wires of carbon nanotubes and metal may provide at least a 5% savings of energy compared to wires currently being used. In the use of high tension electrical power lines, approximately 10% of that power is wasted in Joule heating and other loss mechanisms. Using nanocomposite wires of this invention that provide greater than 100% enhancement could reduce that waste for a potential savings of 5% per year of the total energy. This could result in a national savings of $50 billion per year.

Nanocomposite wires of this invention could also provide considerable energy saving for motors, generators, and electromagnets, which are the highest consumers of electrical power in the USA. The same type of savings described above for electrical power transmission is also possible if nanocomposite wires were used instead of more traditional electrical conductors in motors, generators, and electromagnets. Measurements made in demonstrating this invention used alternating current (AC) techniques. No change was observed if either a 10 or 10,000 hertz frequency was used for the tests. So again, the energy savings here by replacing electrical conductors with nanocomposite wires may be substantial, perhaps as much as $27 billion or more per year.

Another application in which the nanocomposite wires of this invention may be used relates to deep sea drilling for oil. As shallow oil fields have been tested, developed, and become exhausted, the trend has been to examine ever deeper wells. But there is a problem in that the same drill pipe is used for both supplying power to the deep well and pumping the oil up to the surface. The oil industry has developed cables that are now at the limit of their ability to supply power at their present drilling depths. To go deeper, they need to employ conductors with enhanced properties. Using the nanocomposite wires in cables would allow, with over 100% enhanced conductivity, drilling to be roughly twice as deep.

Although the present invention has been described with reference to specific details, it is not intended that such details should be regarded as limitations upon the scope of the invention, except as and to the extent that they are included in the accompanying claims.

What is claimed is:

1. A method for preparing an electrically conducting nanocomposite wire, comprising:
pulling a tow of aligned multiwalled carbon nanotubes from a supported array of the multiwalled carbon nanotubes, and
forming transverse bridges of elemental metal or alloy that connect adjacent carbon nanotubes to each other, the transverse bridges providing paths for electricity to flow from one nanotube to another when a voltage is applied across the nanocomposite wire.

2. The method of claim 1, wherein said multiwalled carbon nanotubes comprise double-walled carbon nanotubes having an inner wall and an outer wall, and wherein said bridges of elemental metal or alloy extend through the outer wall to the inner wall of the double walled carbon nanotubes.

3. The method of claim 1, wherein said step of forming bridges that connect adjacent carbon nanotubes to each other comprising depositing elemental metal or alloy on the tow under conditions suitable for the formation of bridges that connect adjacent carbon nanotubes to each other.

4. The method of claim 1, wherein the elemental metal or alloy is selected from iron, ruthenium, osmium, nickel, palladium, platinum, copper, silver, gold, zinc, cadmium, mercury, aluminum, gallium, indium, tellurium, and alloys thereof.

5. The method of claim 1, wherein the elemental metal is copper.

6. A nanocomposite wire prepared by a process comprising:
pulling a tow of aligned multiwalled carbon nanotubes from a supported array of the multiwalled carbon nanotubes, and
forming transverse bridges that connect adjacent carbon nanotubes to each other, the transverse bridges comprising elemental metal or alloy, said bridges providing paths for electricity to flow from one nanotube to another when a voltage is applied across the nanocomposite wire.

7. The nanocomposite wire of claim 6, wherein said multiwalled carbon nanotubes comprise double-walled carbon nanotube having an inner wall and an outer wall, and wherein said bridges comprising elemental metal or alloy extend through the outer wall to the inner wall of the double-walled carbon nanotubes.

8. The nanocomposite wire of claim 6, wherein said forming of bridges comprises depositing elemental metal or alloy on the tow under conditions suitable for the formation of metal bridges that connect adjacent nanotubes to each other.

9. The nanocomposite wire of claim 6, wherein depositing elemental or alloy on the tow comprises metal sputtering.

10. The nanocomposite wire of claim 6, wherein said elemental metal or alloy is selected from iron, ruthenium, osmium, nickel, palladium, platinum, copper, silver, gold, zinc, cadmium, mercury, aluminum, gallium, indium, tellurium, and alloys thereof.

11. The nanocomposite wire of claim 6, wherein said elemental metal is copper.

12. A nanocomposite wire, comprising:
a tow of aligned multiwalled carbon nanotubes, and
transverse bridges of elemental metal or alloy, said transverse bridges attaching adjacent carbon nanotubes to each other and providing paths for electricity to flow from one nanotube to another.

13. The nanocomposite wire of claim 12, wherein said tow of aligned multiwalled carbon nanotubes comprise double-walled carbon nanotubes having an inner wall and an outer wall, and wherein said bridges comprising elemental metal or alloy extend through the outer wall to the inner wall of the nanotubes.

14. The nanocomposite wire of claim 12, wherein said elemental metal or alloy is selected from iron, ruthenium, osmium, nickel, palladium, platinum, copper, silver, gold, zinc, cadmium, mercury, aluminum, gallium, indium, tellurium, and alloys thereof.

15. The nanocomposite wire of claim 12, wherein said elemental metal comprises copper.
